(19) United States
(12) Patent Application Publication
(10) Pub. No.: US 2025/0119372 A1
(43) Pub. Date: Apr. 10, 2025

(54) REAL-TIME TRANSPORT (RTP) HEADER EXTENSION BINDING AND RTP HEADER EXTENSION FOR IN-BAND DELAY MEASUREMENT ON EITHER END DEVICE

(71) Applicant: QUALCOMM Incorporated, San Diego, CA (US)

(72) Inventors: Liangping Ma, San Diego, CA (US); Imed Bouazizi, Celina, TX (US); Thomas Stockhammer, Bergen (DE); Nikolai Konrad Leung, San Francisco, CA (US)

(21) Appl. No.: 18/904,548

(22) Filed: Oct. 2, 2024

Related U.S. Application Data
(60) Provisional application No. 63/587,905, filed on Oct. 4, 2023.

(51) Int. Cl. H04L 43/0852; H04L 65/65; H04L 65/70

(52) U.S. Cl. CPC H04L 43/0858; H04L 65/65; H04L 65/70

(57) ABSTRACT

An example method includes sending or receiving a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted. The method includes transmitting, by a first device, the first RTP packet and receiving, by the first device, a second RTP packet, the second RTP packet including the second RTP header extension including the first timestamp, a second timestamp, and a third timestamp. The method includes determining, based on at least one of the first timestamp, the second timestamp, or the third timestamp, a delay.

This application claims the benefit of U.S. Provisional Application No. 63/587,905, filed Oct. 4, 2023, the entire contents of which are hereby incorporated by reference.

### TECHNICAL FIELD

This disclosure relates to transport of data, such as Real-Time Transport Protocol (RTP) packets.

### BACKGROUND

Applications, such as extended reality (XR) applications, may be accessed by a device over one or more networks from another device. The one or more networks may include wireless wide area network(s), such as a 5G network, wireless local area network(s), such as a Wi-Fi network, the Internet, or the like. As such the end-to-end connection between the two devices may traverse different types of networks. Traversal of networks by a data packet may cause data packet delay.

### SUMMARY

In general, this disclosure describes techniques for improving accuracy of delay measurements. More particularly, this disclosure describes techniques for more accurately determining end-to-end transportation delay and/or processing delay of data packets, such as RTP and/or secure RTP (SRTP) packets. RTP/SRTP packets may include RTP packets and/or SRTP packets. Information included in RTP header extensions may be used to determine the delay. This disclosure describes techniques for determining delay using RTP header extensions. The determination of delay may be important for quality of experience (QoE) purposes.

In one example, a method includes: transmitting or receiving, by a first device, a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted; transmitting, by the first device, the first RTP packet; receiving, by the first device, a second RTP packet, the second RTP packet comprising the second RTP header extension, the second RTP header extension comprising the first timestamp, a second timestamp indicative of a time at which a second device received the first RTP packet, and a third timestamp indicative of a time at which the second device transmitted the second RTP packet; and determining, based on at least one of the first timestamp, the second timestamp, or the third timestamp, a delay.

In another example, a method includes: transmitting or receiving, by a second device, a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted; receiving, by the second device, the first RTP packet; transmitting, by the second device, a second RTP packet, the second RTP packet comprising the second RTP header extension, the second RTP header extension comprising the first timestamp, a second timestamp indicative of a time at which the second device received the first RTP packet, and a third timestamp indicative of a time at which the second device transmitted the second RTP packet; and determining, based on at least one of the first timestamp, the second timestamp, or the third timestamp, a delay.

In another example, a computing device includes one or more memories for storing the media data; and one or more processors communicatively coupled to the one or more memories, the one or more processors being configured to: transmit or receive a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted; transmit the first RTP packet; receive a second RTP packet, the second RTP packet comprising the second RTP header extension, the second RTP header extension comprising the first timestamp, a second timestamp indicative of a time at which a second device received the first RTP packet, and a third timestamp indicative of a time at which the second device transmitted the second RTP packet; and determine, based on at least one of the first timestamp, the second timestamp, or the third timestamp, a delay.

In another example, a computing device includes one or more memories for storing the media data; and one or more processors communicatively coupled to the one or more memories, the one or more processors being configured to: transmit or receive a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted; receive the first RTP packet; transmit a second RTP packet, the second RTP packet comprising the second RTP header extension, the second RTP header extension comprising the first timestamp, a second timestamp indicative of a time at which the device received the first RTP packet, and a third timestamp indicative of a time at which the device transmitted the second RTP packet; and determine, based on at least one of the first timestamp, the second timestamp, or the third timestamp, a delay.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a block diagram illustrating an example system that implements techniques for streaming media data over a network.

FIG. 1B is a block diagram illustrating another example system that implements techniques for streaming media data over a network.

FIG. 2 is a block diagram illustrating an end-to-end XR system in which data packets traverse more than one network.

FIG. 3 is a conceptual diagram illustrating example delays in an end-to-end connection for an XR application according to one or more aspects of this disclosure.

FIG. 4 is a conceptual diagram illustrating example RTP header extensions for delay measurements according to one or more aspects of this disclosure.

FIG. 5 is a conceptual diagram illustrating an example of the use of a single type of RTP header extension including three timestamps according to one or more aspects of this disclosure.

FIGS. 6A-6B are conceptual diagrams illustrating example the use of timestamps in an RTP header extension according to one or more aspects of this disclosure.

FIGS. 7A-7B are conceptual diagrams illustrating example use of timestamps in a payload of an RTP packet according to one or more aspects of this disclosure.

FIG. 8 is a flow diagram illustrating example delay measurement techniques according to one or more aspects of this disclosure.

FIG. 9 is a flow diagram illustrating example other delay measurement techniques according to one or more aspects of this disclosure.

### DETAILED DESCRIPTION

In general, this disclosure describes techniques for using RTP header extensions to determine delay measurements. More particularly, this disclosure describes techniques for negotiating a binding two RTP header extensions, for example, of different types. The header extensions may include one or more timestamps for determining delay measurements, such as round trip time (RTT), one way delay, and/or processing delays. The determination of such delays may be important to quality of experience (QoE) for an application as the navigation of packets over more than one type of network may make it more difficult to control an end-to-end delay. The techniques of this disclosure may address that issue by informing a network device(s) of delays so as to allow that network device(s) to negotiate and implement an appropriate delay over at least one of the networks to meet an overall end-to-end delay for QoE purposes. For example, a network device may use a determined delay to change prioritization of packets for an application to meet such a delay.

In extended reality (XR) applications, an end-to-end connection may include both wireless wide area networks, such as 5G networks, and non-wireless wide area networks (e.g., non-5G networks). The non-5G networks may include the Internet, wireless local area networks (e.g., Wi-Fi networks), etc. While the techniques of this disclosure may be applicable to wireless wide area networks other than 5G networks, for the ease of description, a 5G network is used hereinafter as a representative example of a wireless wide area network.

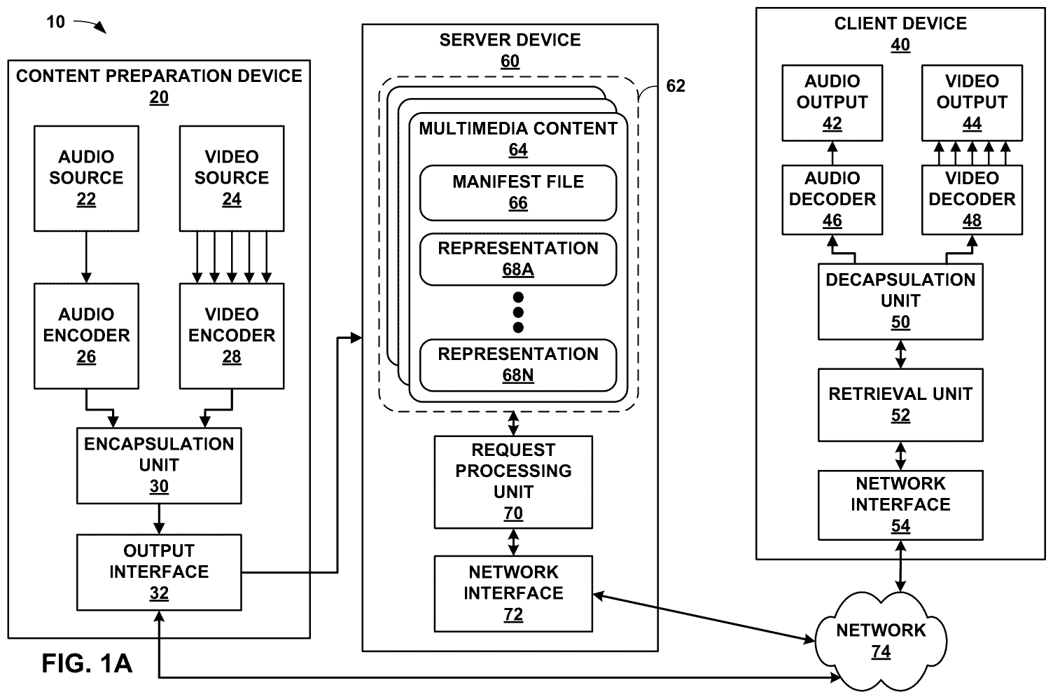

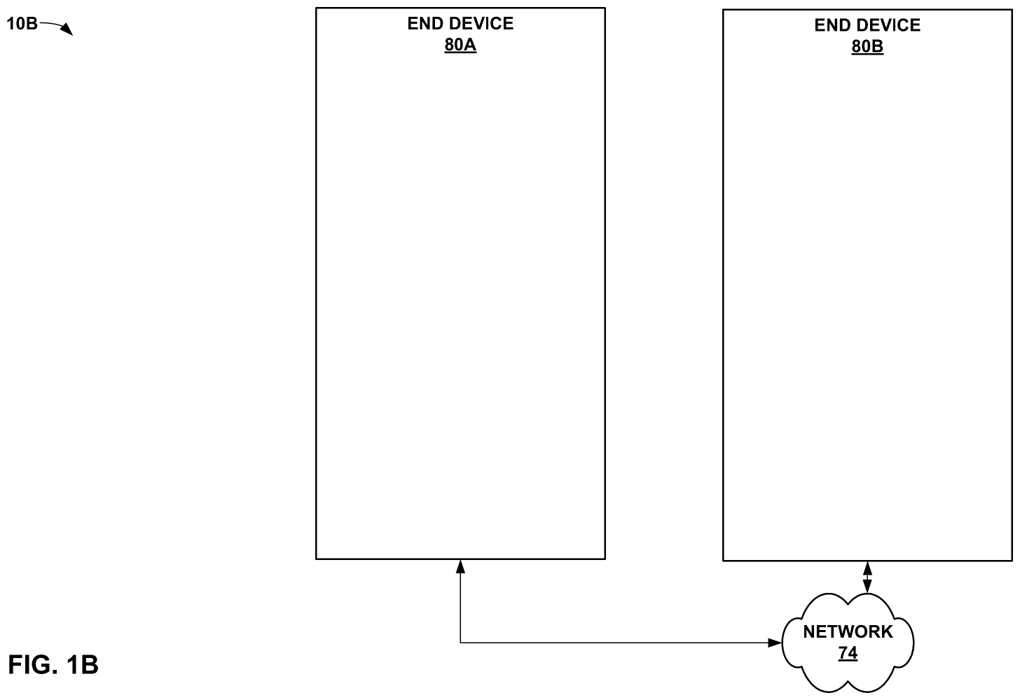

FIG. 1A is a block diagram illustrating an example system 10 that implements techniques for streaming media data over a network. In this example, system 10 includes content preparation device 20, server device 60, and client device 40. Server device 60 may be an XR application server. Client device 40 and server device 60 are communicatively coupled by network 74, which may comprise a wireless wide area network, a wireless local area network, the Internet, and/or the like. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1A, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium including stored audio data, and video source 24 may comprise a computer-readable storage medium including stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame including a timestamp and a video frame including the same timestamp. Content preparation device 20 may include an internal clock from which audio encoder 26 and/or video encoder 28 may generate the timestamps, or that audio source 22 and video source 24 may use to associate audio and video data, respectively, with a timestamp. Note that these timestamps may be different than timestamps discussed herein with respect to use for determining a data packet delay.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1A, encapsulation unit 30 of content preparation device 20 receives elementary streams including coded video data from video encoder 28 and elementary streams including coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of Scalable Video Coding (SVC) and view scalability information SEI messages in Multiview Video Coding (MVC). These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1A, server device 60 includes storage medium 62 that stores various multimedia content 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. In some examples, request processing unit 70 may receive network requests from client device 40 in the form of RTP/SRTP packets and may deliver content, such as XR application content, to client device 40 in the form of RTP/SRTP packets.

Additionally, or alternatively, request processing unit 70 may implement hypertext transfer protocol (HTTP) version 1.1, as described in RFC 2616, “Hypertext Transfer Protocol-HTTP/1.1,” by R. Fielding et al, Network Working Group, Internet Engineering Task Force (IETF), June 1999. That is, request processing unit 70 may be configured to receive HTTP GET or partial GET requests and provide data of multimedia content 64 in response to the requests. The requests may specify a segment of one of representations 68, e.g., using a uniform resource locator (URL) of the segment. In some examples, the requests may also specify one or more byte ranges of the segment, thus including partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally, or alternatively, request processing unit 70 may be configured to deliver media data via a broadcast or multicast protocol, such as evolved Multimedia Broadcast Multicast Services (eMBMS). Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1A, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bit rate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units including a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as including all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

The example of FIG. 1A describes the use of RTP, DASH, and HTTP-based streaming for purposes of example. However, it should be understood that other types of protocols may be used to transport media data. For example, request processing unit 70 and retrieval unit 52 may be configured to operate according to Real-time Streaming Protocol (RTSP), or the like, and use supporting protocols such as Session Description Protocol (SDP) or Session Initiation Protocol (SIP).

FIG. 1B is a block diagram illustrating another example system that implements techniques for streaming media data over a network. FIG. 1B is similar to the example of FIG. 1A, but FIG. 1B includes two end devices, rather than a client device and a server device. For example, each end device 80A and 80B of system 10B may be configured to both consume content from and provide content to the other of end device 80A and 80B. The system of FIG. 1B may implement the techniques disclosed herein.

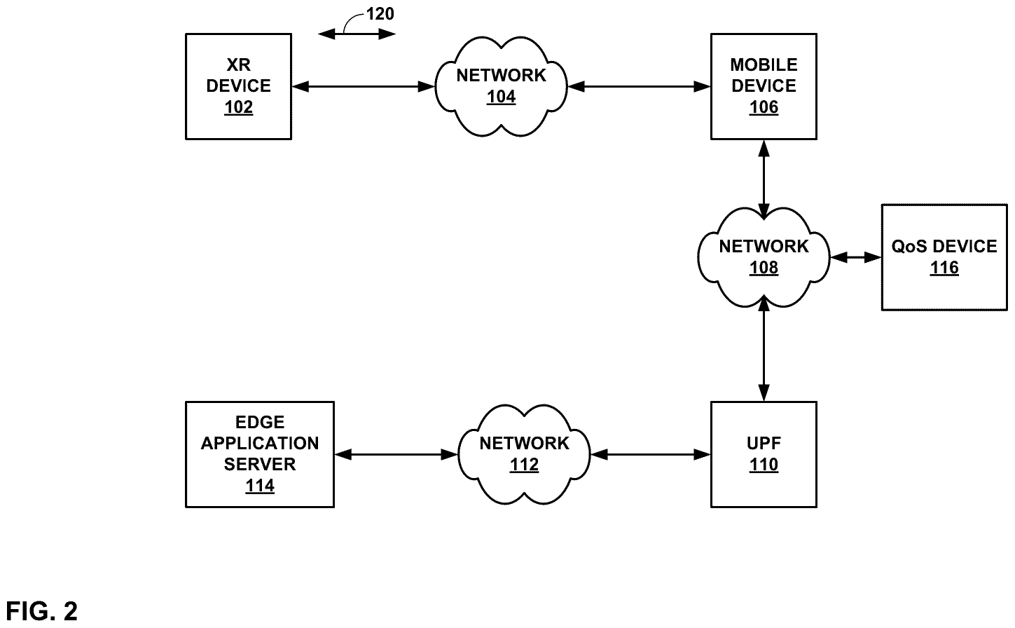

FIG. 2 is a block diagram illustrating an end-to-end XR system in which data packets traverse more than one network. XR device 102, which may be an example of client device 40 or a portion thereof, may be coupled to network 104. In some examples, XR device 102 may include XR glasses or an XR headset configured to deliver XR content to a user. In some examples, network 104 may include a wireless local area network, such as a Wi-Fi network. In some examples, network 104 may include multiple networks, such as a Wi-Fi network cascaded with an Ethernet.

Mobile device 106, which may be an example of client device 40 or a portion thereof, may be coupled to network 104 and network 108. Network 108 may include a wireless wide area network, such as a 5G network.

User plane function (UPF) 110 may be coupled to network 108 and network 112. Network 112 may include the Internet. In some examples, network 112 may also include one or more local networks. Edge application server (EAS) 114, which may be an example of server device 60, may be coupled to network 112 and to content preparation device 20 (not shown in FIG. 2). As such, an end-to-end connection between XR device 102 and EAS 114 may traverse a plurality of networks, such as network 104, network 108, and network 112. These networks may be networks of different types, having different delay properties and different mechanisms for determining delay, for example, for quality of service (QOS) or QoE purposes. As such, techniques for determining an end-to-end delay may be desirable.

In some examples, network 108 may be coupled with QoS device 116. QoS device may be any computing device that may compute delays or compare delays to delay thresholds for QoS or QoE purposes.

Computing devices, such as XR device 102 and EAS 114, may exchange one or more SDP messages 120 to negotiate a binding between RTP packets such that a first timestamp sent in a first type of RTP header extension in a first RTP packet sent by one of the computing devices is the same as a first timestamp sent in a second type of RTP header extension in a second RTP packet sent by another of the computing devices.

For example, XR device 102 may transmit or receive an SDP message (of one or more SDP messages 120) that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted. XR device 102 may transmit the first RTP packet. XR device 102 may receive a second RTP packet, the second RTP packet including the second RTP header extension, the second RTP header extension including the first timestamp, a second timestamp indicative of a time at which a second device received the first RTP packet, and a third timestamp indicative of a time at which the second device transmitted the second RTP packet. XR device 102 may determine, based on at least one of the first timestamp, the second timestamp, or the third timestamp, a delay.

For example, EAS 114 may transmit or receive an SDP message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted. EAS 114 may receive the first RTP packet. EAS 114 may transmit a second RTP packet, the second RTP packet including the second RTP header extension, the second RTP header extension including the first timestamp, a second timestamp indicative of a time at which the second device received the first RTP packet, and a third timestamp indicative of a time at which the second device transmitted the second RTP packet. EAS 114 may determine, based on at least one of the first timestamp, the second timestamp, or the third timestamp, a delay.

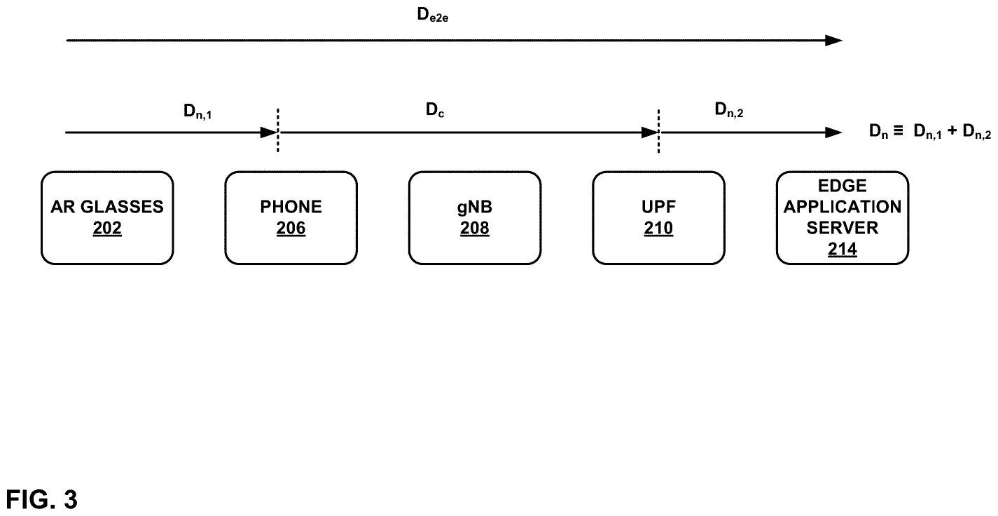

FIG. 3 is a conceptual diagram illustrating example delays in an end-to-end connection for an XR application according to one or more aspects of this disclosure. In the example of FIG. 3, the wireless wide area network (such as network 108) may be a 3GPP network (e.g., a 5G network), represented as gNodeB (gNB) 208 in FIG. 3. As can be seen in FIG. 3, the end-to-end delay Dₑ₂ₑ may be equal to the in the 5G network Dc between phone 206 (which may be an example of mobile device 106) and UPF 210 (which may be an example of UPF 110), plus the delay from the augmented reality (AR) glasses 202 (which is an example of XR device 102) to phone 206, D_{n,1} and the delay from UPF 210 to EAS 214, D_{n,2}. The non-3GPP network delay Dₙ, which may include delay other than delay in the 5G network Dc, may therefore be equal to the delays D_{n,1}+D_{n,2}.

Delay measurement may be important for XR applications, for example. Delay provisioning by a 3GPP network (e.g., a 5G network) may include provisioning for an end-to-end connection that includes both 3GPP networks and non-3GPP networks (such as the Internet, Wi-Fi, and/or the like). End-to-end delay measurements may allow the delay within the non-3GPP network Dₙ to be derived.

For example, the 3GPP network (e.g., gNB 208) may provision a delay Dc to achieve a target end-to-end delay Dₑ₂ₑ according to Dc=Dₑ₂ₑ−Dₙ. When delay monitoring, such as for XR applications, the measured delay should be representative of the delay experienced by data packets. For example, data packets undergoing the same QoS or QoE treatment, having a similar packet size, and/or the like. As such, piggybacking the delay measurement within the data packets (e.g., vian RTP header extensions), such as using in-band delay measurement, may be desirable.

The non-5G network delays may be estimated via end-to-end delay measurements. There are existing schemes or techniques to measure 5G network delay Dc, e.g., per TS23.501 clause 5.33.3. Measurement packets (on the 5G network and non-5G networks) should be representative of XR data packets: e.g., have a same QoS or QoE treatment, similar packet size, etc.

However, the QoS or QoE treatment received by measurement packets may be different from that received by the data packets themselves, e.g., using out-of-band measurement techniques. For example, in the 5G network, a measurement message and a data packet may use different protocols (e.g., Internet Control Message Protocol (ICMP) messages (Echo or Echo Reply). For example, the measurement message may have protocol number 1, while data packets (RTP/UDP) may have protocol number 17. A measurement message and a data packet may have different IP 5-tuples (IP source address, IP destination address, source port number, destination port number, protocol number). A measurement message and a data packet may be mapped to different QoS flows, and may receive different QoS treatment in the 5G network. On the Internet, the measurement packet and the data packet may differ in the Differentiated Services Code Point (DSCP) value in the IP packet header. In a Wi-Fi network (e.g., network 104), the measurement packet and the data packet may be mapped to different access categories. Additionally, the packet size difference between the measurement packet and the data packet may affect the accuracy of the delay measurement, especially for low bit rate links.

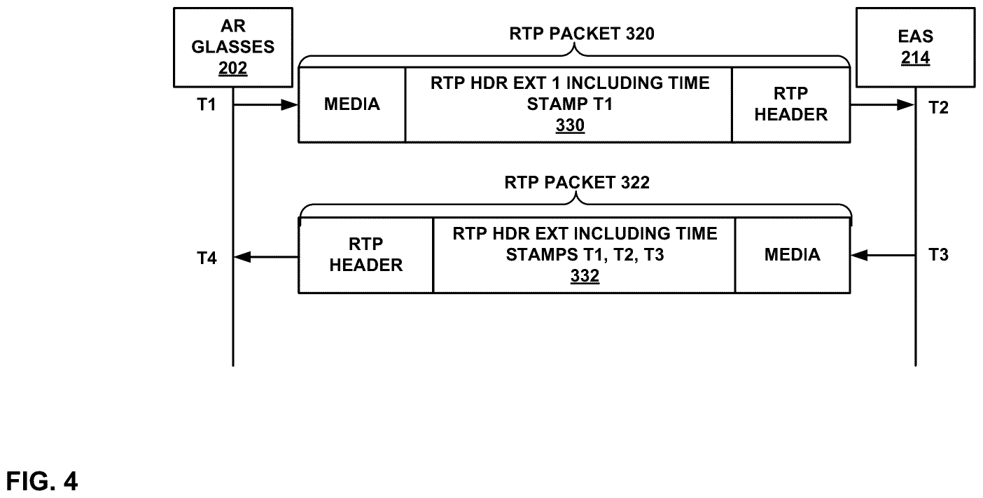

FIG. 4 is a conceptual diagram illustrating example RTP header extensions for delay measurements according to one or more aspects of this disclosure. T1 may be a timestamp that is indicative of a time when AR glasses 202 sends RTP packet 320. T2 may be a timestamp that is indicative of a time when EAS 214 receives RTP packet 320. T3 may be a timestamp that is indicative of a time when EAS 214 sends RTP packet 322. T4 may be a time when AR glasses 202 receives RTP packet 322. With the use of RTP header extensions, such as those of FIG. 4, the delay measurements may be carried as follows. The one-way delay from the AR glasses 202 to the EAS 214 may be determined as T2−T1. The one-way delay in the opposite direction may be determined as T4−T3. The round trip time (RTT) may be determined as T4−T1−(T3−T2). In this example, AR glasses 202 may determine the one-way delay from the AR glasses 202 to the EAS 214, the one-way delay in the opposite direction, and the RTT, based on times and/or timestamps available to AR glasses 202. EAS 214 may determine the one-way delay from the AR glasses 202 to the EAS 214 and/or a processing delay of EAS 214 based on times and/or timestamps available to EAS 214.

The sizes of the RTP header extension 330 of RTP packet 320 and RTP header extension 332 of RTP packet 322 may be different because RTP header extension 330 includes one timestamp (e.g., T1), while RTP header extension 332 includes three timestamps (e.g., T1, T2, and T3).

The fields (e.g., for T1 and T2) in RTP header extension 332 may depend on the RTP header extension 330. For example, T1 in RTP header extension 332 may be the same as T1 in RTP header extension 330 (e.g., a time that AR glasses 202 sent RTP packet 320) and T2 may represent the time EAS 214 received RTP packet 320. As such, this dependency (or binding) between RTP header extension 330 and RTP header extension 332 should be agreed upon between the sender (e.g., AR glasses 202) and the receiver (e.g., EAS 214).

For example, EAS 214 should know what T1 and T2 mean, because EAS 214 may insert T1 and T2 into RTP header extension 332. For example, if EAS 214 does not know what T1 and T2 means, EAS 214 may not include the proper values for T1 and T2 in RTP header extension 332 of packet 322, which may result in an improper determination of delays, for example, by AR glasses 202. In some examples, AR glasses 202, EAS 214, or one or more other device(s) of a network (e.g., gNB 208) may use session data protocol (SDP) to bind two header extensions (HE 1 and HE 2) by specifying that T1 is a timestamp carried in an RTP HE of a type 1 (carrying only one timestamp) (e.g., RTP header extension 330) of an RTP packet (RTP packet 320) and/or that T2 is the arrival time of RTP HE of type 1 (e.g., RTP header extension 330) of RTP packet 320.

For example, AR glasses 202 may transmit or receive an SDP message that includes binding information that associates a first type of RTP header extension and a second type of RTP header extension for an RTP session. The binding information may be indicative of a first timestamp in the first type of RTP header extension, and the first timestamp in the second type of RTP header extension, both being indicative of a time at which a first RTP packet including the first RTP header extension is transmitted. AR glasses 202 may transmit the first RTP packet. AR glasses 202 may receive a second RTP packet, the second RTP packet including the second type of RTP header extension, the second type of RTP header extension including the first timestamp, a second timestamp indicative of a time at which EAS 214 received the first RTP packet, and a third timestamp indicative of a time at which EAS 214 device transmitted the second RTP packet. AR glasses 202 may determine, based on at least one of the first timestamp, the second timestamp, or the third timestamp, a delay.

For example, EAS 214 may transmit or receive an SDP message that includes binding information that associates a first type of RTP header extension and a second type of RTP header extension for an RTP session. The binding information may be indicative of a first timestamp in the first type of RTP header extension, and the first timestamp in the second type of RTP header extension, both being indicative of a time at which a first RTP packet including the first RTP header extension is transmitted. EAS 214 may receive the first RTP packet. EAS 214 may transmit a second RTP packet, the second RTP packet including the second type of RTP header extension, the second type of RTP header extension including the first timestamp, a second timestamp indicative of a time at which EAS 214 received the first RTP packet, and a third timestamp indicative of a time at which EAS 214 transmitted the second RTP packet. EAS 214 may determine, based on at least one of the first timestamp, the second timestamp, or the third timestamp, a delay.

For example, the end devices in an RTP session (e.g., AR glasses 202 and EAS 214) may negotiate (via SDP) the binding of timestamps between two types of RTP header extensions. For example, RTP header extensions having a single timestamp T1, such as RTP header extension 330, may be referred to as a first type of RTP header extension and RTP header extensions having three timestamps, T1, T2, and T3, such as RTP header extension 332, may be referred to as a second type of RTP header extension. Each RTP header extension may have its own identifier (ID). In some examples, the RTP header extension may be defined in a one-byte format (e.g., short) or a two-byte format (e.g., long). In some examples, there may be multiple instances of a type of RTP header extension during the RTP session and the identifiers may help computing devices distinguish between the different RTP packets for binding purposes.

In some examples, field(s) in the first type of RTP header extension may be mapped to field(s) in the second type of RTP header extension. For example, for delay measurements discussed herein, T1 in the first type of RTP header extension may be mapped to T1 in the second type of RTP header extension. As such, devices sending or receiving particular RTP packets having the first type of RTP header extension or the second type of RTP header extension may associate particular T1s with each other. In this manner, a device may use associated T1s as part of determining one or more delay measurements.

In some examples, definition of fields in the second type of RTP header extension may be based on events associated with the first type of RTP header extension. For example, the definition of T2 in the second type of RTP header extension may be the time of arrival of an RTP packet (e.g., RTP packet 320) that includes an RTP header extension of the first type.

In some examples, association between RTP packets carrying RTP header extensions may indicate a cause and effect. For example, in a delay measurement, the indication may be a processing delay: e.g., the last RTP packet carrying an image sent by a user equipment (UE) to a cloud server for image segmentation is associated with the first RTP packet (e.g., RTP packet 320) carrying the segmentation result.

For example, the augmented Backus-Naur form (ABNF) syntax in SDP may include:

extmap-attr=“a=extmap:” header-ext-ID-1[“/” direction] SP
www.webrtc.org/experiments/rtp-hdrext/abs-send-time
extmap-attr=“a=extmap:” header-ext-ID-2[“/” direction] SP
urn:3gpp:delay-
measurement-1-timestamps:rel-18 SP (format SP dependent-extmap-ID)
header-ext-ID-1 =1*3DIGIT
header-ext-ID-2 =1*3DIGIT
direction = “sendonly” / “recvonly” / “sendrecv” / “inactive”
format = “short” / “long”
dependent-extmap-ID = header-ext-ID-1

In some examples, a single type of RTP header extension may be used for delay measurements. For example, the RTP header extension may include 3 timestamps, such as is discussed in U.S. patent application Ser. No. 18/782,823, filed on Jul. 24, 2024, which is hereby incorporated by reference. For example, the RTP header extension may include timestamps T1, T2, and T3. In another example, the RTP header extension may include two timestamps and a time difference, e.g., T1, T2, and ΔT=T3−T1. In yet another example, the RTP header extension may include one timestamp and two time differences, e.g., T1, T2−T1 and T3−T2. In some examples, a timestamp may take up 24 bits of the 32-bit Network Time Protocol (NTP) short format, e.g., X least significant bits (LSBs) of the ‘Seconds’ portion and 24−X (24 minus X) most significant bits (MSBs) of the ‘Fraction’ portion, where X may be equal to 12, 8, 6, 4, 3, 2, or 1. In some examples, the time differences may take up a fewer number of bits.

In some examples, the interpretations of the timestamps may be different than for the example where there is more than one type of RTP header extension. For example, T1 may be interpreted as the time when an RTP packet carrying the RTP header extension of the same type in the opposite direction is transmitted. T2 may be interpreted as the time when an RTP packet carrying the RTP header extension of the same type in the opposite direction is received. T3 may be interpreted the same: as the time when the RTP packet carrying this RTP header extension is transmitted. In some examples, if there are no previous packets received in the opposite direction, the device may set T1 and T2 to a special (e.g., predetermined) value, e.g., 0.

In some examples, the T1 and T2 fields in the RTP header extension of a second RTP packet (e.g., RTP packet 322) are the transmit time and receive time, respectively, of a first RTP packet (e.g., RTP packet 320) that carries an RTP header extension and that causes the generation of the second RTP packet. For example, the first RTP packet may carry an image sent by a UE to the cloud server for image segmentation and the second RTP packet may carry the image segmentation result.

With the single RTP header extension described above, there would only be a need to define a single RTP header extension and there would be no need for a binding as described with the use of two types of RTP header extensions as described herein. Additionally with the use of the single RTP header extension, both of the end devices can derive the two one-way delays, round trip time (RTT), and the processing delay (T3−T2).

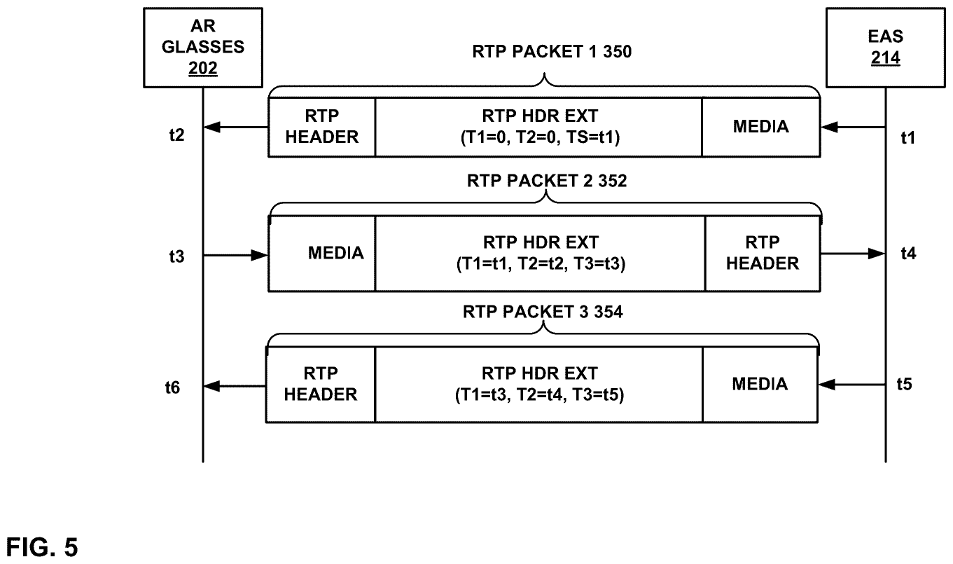

FIG. 5 is a conceptual diagram illustrating an example of the use of a single type of RTP header extension including three timestamps according to one or more aspects of this disclosure. As can be seen, both AR glasses 202 and EAS 214 may determine one-way delays, RTT and a processing delay.

In the example of FIG. 5, t1 represents a time at which EAS 214 sends RTP packet 1 350, t2 represents a time at which AR glasses 202 receives RTP packet 1 350, t3 represents a time at which AR glasses 202 sends RTP packet 2 352, t4 represents a time at which EAS 214 receives RTP packet 2 352, t5 represents a time at which EAS 214 send RTP packet 3 354, and t6 represents a time at which AR glasses 202 receives RTP packet 3 354. AR glasses 202 may send RTP packet 2 352 in response to receiving RTP packet 1 350, and EAS 214 may send RTP packet 3 354 in response to receiving RTP packet 2 352.

For example, EAS 214 may include a value of T1 as 0, T2 as 0, and T3 as t1 (the time EAS 214 transmits RTP packet 1 350) in the RTP header extension of RTP packet 1 350. AR glasses 202 may include a value of T1 as t1 (e.g., from the RTP header extension of RTP packet 1 350), T2 as t2 (the time AR glasses 202 received RTP packet 1 350), and T3 as t3 (the time AR glasses 202 transmits RTP packet 2 352) in the RTP header extension of RTP packet 2 352. EAS 214 may include a value of T1 as t3 (e.g., from the RTP header extension of RTP packet 2 352), T2 as t4 (the time EAS 214 received RTP packet 1 350), and T3 as t5 (the time EAS 214 transmits RTP packet 3 354) in the RTP header extension of RTP packet 3 354.

In this manner, in the example of FIG. 5, AR glasses 202 may determine or measure delays as follows: the delay from AR glasses 202 to EAS 214 equals t4−t3, the delay from EAS 214 to AR glasses 202 equals t2−t1 or t6−t5, the RTT equals t6−t3−(t5−t4), and/or the processing delay on EAS 214 equals t5−t4. EAS 214 may determine or measure delays as follows: the delay from AR glasses 202 to EAS 214 equals t4−t3, the delay from EAS 214 to AR glasses 202 equals t2−t1, the RTT equals t4−t1−(t3−t2), and the processing delay on AR glasses 202 equals t3−t2.

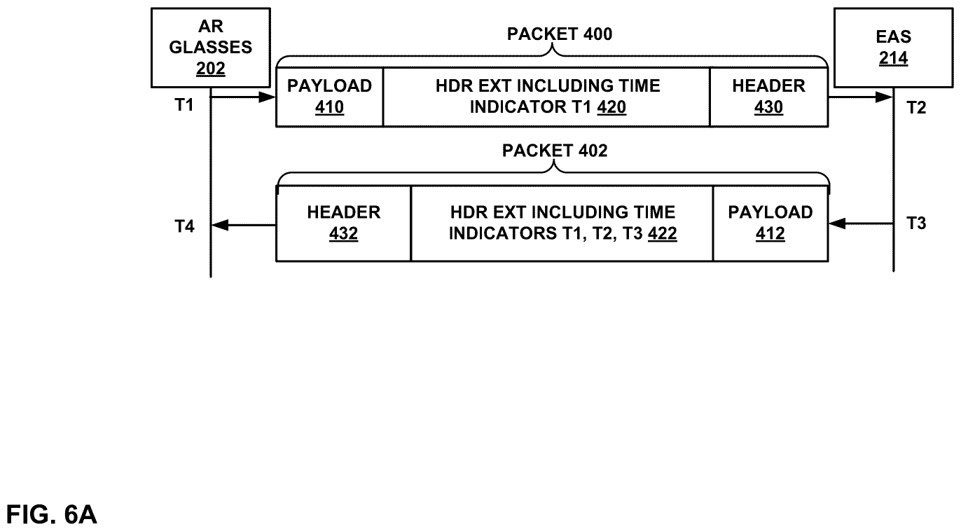

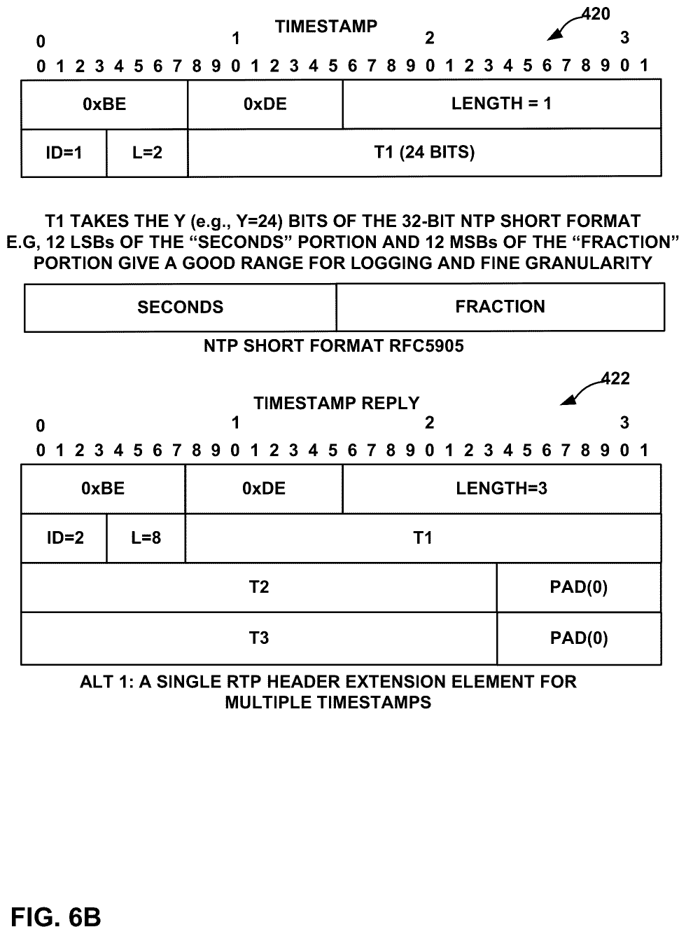

FIGS. 6A-6B are conceptual diagrams illustrating example the use of timestamps in an RTP header extension according to one or more aspects of this disclosure. In FIG. 6A, packet 400 may be an RTP packet. Packet 400 may include: a payload 410, which, for example, may include video data; a header extension 420, which may include one or more header extension elements, carrying a first time indicator T1; and a header 430, which may be an RTP header. For example, AR glasses 202 may generate packet 400 to send to EAS 214.

Packet 402 may also be an RTP packet. Packet 402 may include: a payload 412, which in this example may include video data; a header extension 422, which may include one or more header extension elements, carrying first time indicator T1, a second time indicator T2, and a third time indicator T3; and a header 432, which may be an RTP header. EAS 214 may determine second time indicator T2 upon receiving packet 400 and may determine third time indicator T3 after processing packet 400 and before transmitting packet 402. In some examples, a difference between second time indicator T2 and third time indicator T3 may represent a processing delay associated with EAS 214 processing packet 400.

AR glasses 202 may determine a fourth time indicator T4 upon receiving packet 402. AR glasses 202 may use first time indicator T1, second time indicator T2, third time indicator T3, and/or time indicator T4 when determining a data packet delay.

In FIG. 6B, example formats for RTP header extension 420 and RTP header extension 422 are depicted. For example, RTP header extension 420 includes T1, while RTP header extension 422 includes T1, T2, and T3. RTP header extension 420 may include an identifier (ID) which may have a different value than an ID of RTP header extension 422. The value of the ID may identify the RTP header extension, including whether an RTP header extension is a first type of RTP header extension (e.g., includes one timestamp, T1) or is a second type of RTP header extension (e.g., includes timestamps T1, T2, and T3).

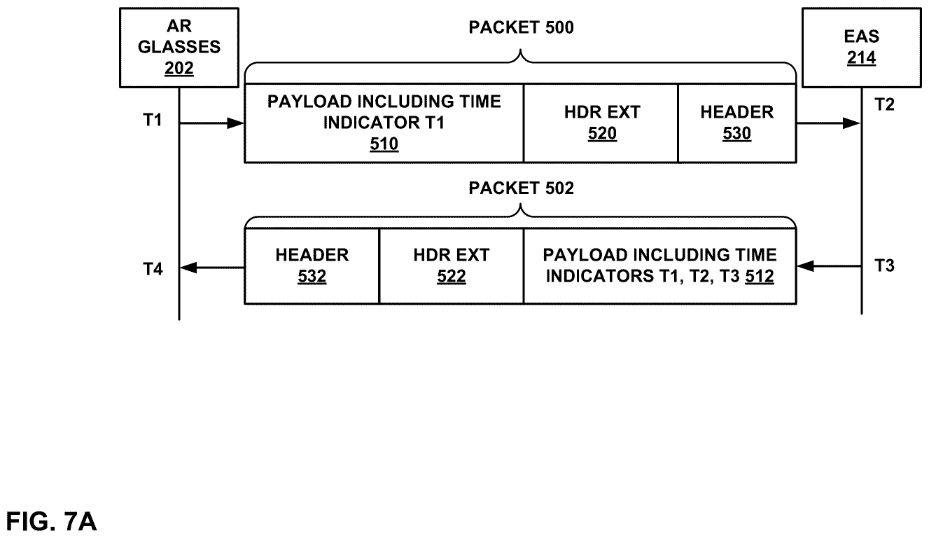

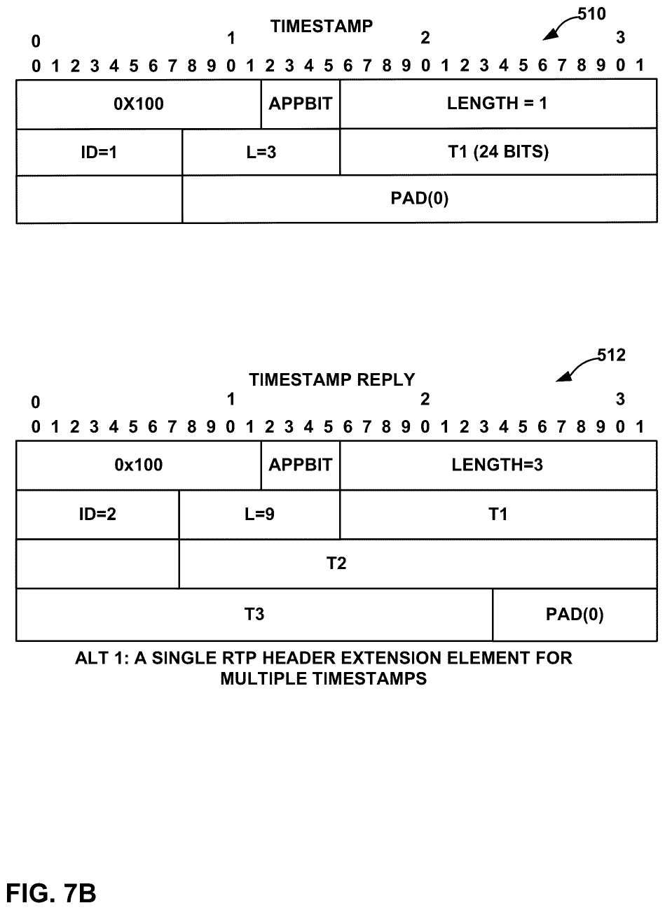

FIGS. 7A-7B are conceptual diagrams illustrating example use of timestamps in a payload of an RTP packet according to one or more aspects of this disclosure. In FIG. 7A, packet 500 may be an RTP packet. Packet 500 may include: a payload 510, which may include first time indicator T1 and, for example, video data; a header extension 520, which may include one or more header extension elements, carrying information relating to first time indicator T1; and a header 530, which may be an RTP header.

Packet 502 may also be an RTP packet. Packet 502 may include: a payload 512, which in this example may include first time indicator T1, a second time indicator T2, a third time indicator T3, and video data; a header extension 522, which may include one or more header extension elements, carrying information relating to first time indicator T1, second time indicator T2, and third time indicator T3; and a header 532, which may be an RTP header. EAS 214 may determine second time indicator T2 upon receiving packet 500 and may determine third time indicator T3 after processing packet 500 and before transmitting packet 502. In some examples, a difference between second time indicator T2 and third time indicator T3 may represent a processing delay associated with EAS 214 processing packet 500.

AR glasses 202 may determine a fourth time indicator T4 upon receiving packet 502. AR glasses 202 may use first time indicator T1, second time indicator T2, third time indicator T3, and/or time indicator T4 when determining a data packet delay.

In FIG. 7B, example formats for the timestamp(s) in payload 510 and payload 512 are depicted. For example, payload 510 includes T1, while payload 512 includes T1, T2, and T3.

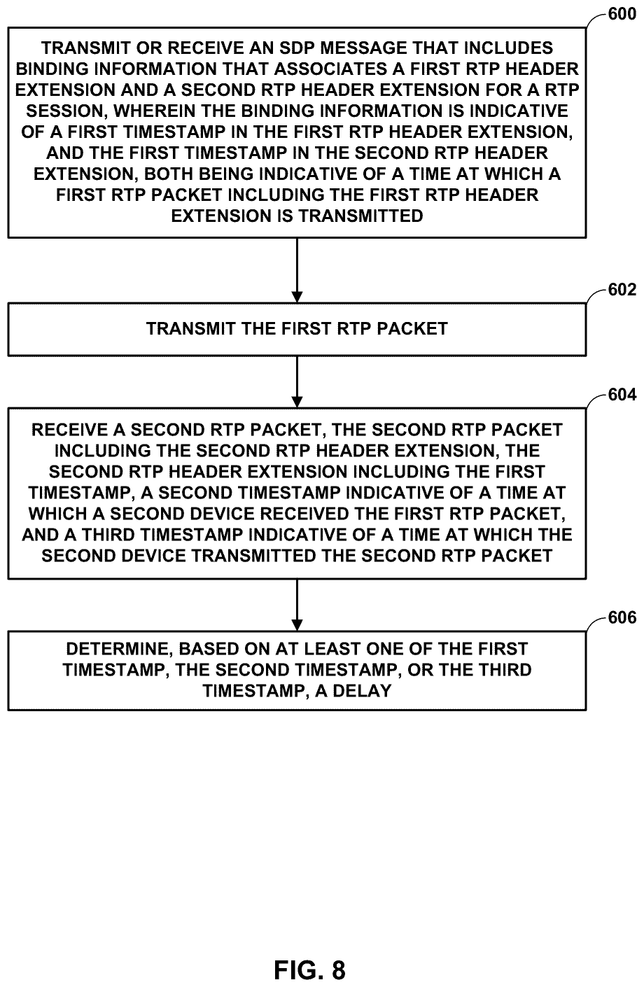

FIG. 8 is a flow diagram illustrating example delay measurement techniques according to one or more aspects of this disclosure. FIG. 8 is described with respect to AR glasses 202, but the techniques of FIG. 8 may be performed by any device capable of performing such techniques.

AR glasses 202 may transmit or receive an SDP message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted (600). For example, AR glasses 202 may transmit to EAS 214 or receive from EAS 214 an SDP message of one or more SDP messages 120. The SDP message may associate a first RTP header extension (e.g., RTP header extension 330 having one timestamp T1) and a second RTP header extension (e.g., RTP header extension 332 having timestamps T1, T2, and T3) for an RTP session between AR glasses 202 and EAS 214. The binding information may be indicative of T1 in the first RTP header extension and T1 in the second RTP header extension both being indicative of a time at which a first RTP packet including the first RTP header extension is transmitted by AR glasses 202.

AR glasses 202 may transmit the first RTP packet (602). For example, AR glasses 202 may transmit RTP packet 320 to EAS 214.

AR glasses 202 may receive a second RTP packet, the second RTP packet including the second RTP header extension, the second RTP header extension including the first timestamp, a second timestamp indicative of a time at which a second device received the first RTP packet, and a third timestamp indicative of a time at which the second device transmitted the second RTP packet (604). For example, AR glasses 202 may receive RTP packet 322 from EAS 214. RTP packet 322 may include RTP header extension 332 of the second type which includes timestamps T1, T2, and T3. Timestamp T1 may be the same as timestamp T1 in the RTP header extension 330 of the first type in RTP packet 320. Timestamp T2 may be indicative of a time that EAS 214 received RTP packet 320. Timestamp T3 may be indicative of a time that EAS 214 sent RTP packet 322.

AR glasses 202 may determine, based on at least one of the first timestamp, the second timestamp, or the third timestamp, a delay (606). For example, AR glasses 202 may determine a delay from the first device to the second device by subtracting a value of the first timestamp (T1) from a value of the second timestamp (T2), wherein the delay=T2−T1. For example, AR glasses 202 may determine a delay a delay from the second device to the first device by subtracting a value of the third timestamp (T3) from a value indicative of a time the second RTP packet is received by the first device (T4), wherein the delay=T4−T3. For example, AR glasses 202 may determine a RTT by subtracting a difference between the value of a third timestamp (T3) and a value of the second timestamp (T2) from a difference between a value indicative of a time the second RTP packet is received by the first device (T4) and a value of the first timestamp (T1), wherein the RTT=(T4−T1)−(T3−T2). For example, AR glasses 202 may determine a processing delay by subtracting a value of the second timestamp (T2) from a value of the third timestamp (T3), wherein the processing delay=T3−T2.

In some examples, AR glasses 202 may negotiate with EAS 214, a binding of the first RTP header extension and the second RTP header extension, wherein negotiating the binding includes transmitting or receiving the SDP message. In some examples, determining the delay is performed by at least one of the first device (e.g., AR glasses 202) or another device (e.g., QoS device 116 of FIG. 2). In some examples, the SDP message further includes an indication of a format of at least one of the first RTP header extension or the second RTP header extension as short or long.

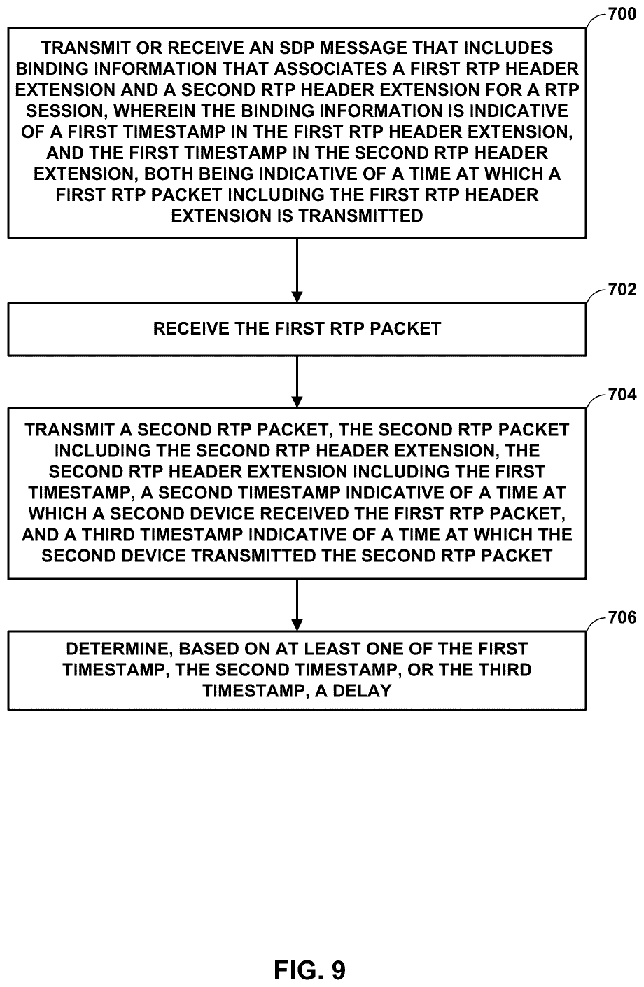

FIG. 9 is a flow diagram illustrating example other delay measurement techniques according to one or more aspects of this disclosure. FIG. 9 is described with respect to EAS 214, but the techniques of FIG. 9 may be performed by any device capable of performing such techniques.

EAS 214 may transmit or receive an SDP message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted (700). For example, EAS 214 may transmit to AR glasses 202 or receive from AR glasses 202 an SDP message of one or more SDP messages 120. The SDP message may via binding information associate a first RTP header extension (e.g., RTP header extension 330 having one timestamp T1) and a second RTP header extension (e.g., RTP header extension 332 having timestamps T1, T2, and T3) for an RTP session between EAS 214 and AR glasses 202. The binding information is indicative of T1 in the first RTP header extension and T1 in the second RTP header extension both being indicative of a time at which a first RTP packet including the first RTP header extension is transmitted by AR glasses 202.

EAS 214 may receive the first RTP packet (702). For example, EAS 214 may receive RTP packet 320 from AR glasses 202.

EAS 214 may transmit a second RTP packet, the second RTP packet including the second RTP header extension, the second RTP header extension including the first timestamp, a second timestamp indicative of a time at which the second device received the first RTP packet, and a third timestamp indicative of a time at which the second device transmitted the second RTP packet (704). For example, EAS 214 may transmit RTP packet 322 to AR glasses 202. RTP packet 322 may include RTP header extension 332 of the second type which includes timestamps T1, T2, and T3. Timestamp T1 may be the same as timestamp T1 in the RTP header extension 330 of the first type in RTP packet 320. Timestamp T2 may be indicative of a time that EAS 214 received RTP packet 320. Timestamp T3 may be indicative of a time that EAS 214 sent RTP packet 322.

EAS 214 may determine, based on at least one of the first timestamp, the second timestamp, or the third timestamp, a delay (706). For example, EAS 214 may determine a delay from the first device to the second device by subtracting a value of the first timestamp (T1) from a value of the second timestamp (T2), wherein the delay=T2−T1. For example, EAS 214 may determine a processing delay by subtracting a value of the second timestamp (T2) from a value of the third timestamp (T3), wherein the processing delay=T3−T2.

In some examples, EAS 214 may negotiate, with AR glasses 202, a binding of the first RTP header extension and the second RTP header extension, wherein negotiating the binding comprises transmitting or receiving the SDP message. In some examples, determining the delay is performed by at least one of the second device (e.g., EAS 214) or another device (e.g., QoS device 116 of FIG. 2). In some examples, the SDP message further includes an indication of a format of at least one of the first RTP header extension or the second RTP header extension as short or long.

Various examples of the techniques of this disclosure are summarized in the following clauses:

Clause 1A. A method comprising: communicating, by a first computing device with a second computing device, via a protocol regarding at least one field of a first type of Real-Time Transport Protocol (RTP) header extension; binding, by the first computing device, based on the communicating, the at least one field of the first type RTP header extension to at least one field of a second type of RTP header extension; and determining a delay based on the binding.

Clause 2A. The method of clause 1A, wherein the protocol comprises session description protocol.

Clause 3A. The method of clause 1A or clause 2A, wherein the at least one field of the first type of RTP header extension comprises a timestamp field.

Clause 4A. The method of any of clauses 1A-3A, wherein the first type of RTP header extension comprises a first identifier and the second type of RTP header extension comprises a second identifier, the first identifier being different from the second identifier.

Clause 5A. The method of any of clauses 1A-4A, wherein the binding comprises mapping a first field in the first type of RTP header extension to a first field in the second type of RTP header extension.

Clause 6A. The method of clause 5A, wherein the first field comprises a first timestamp indicative of a time a first RTP packet comprising the first type of RTP header extension is transmitted by the first computing device or the second computing device.

Clause 7A. The method of any of clauses 1A-6A, wherein the binding comprises mapping a second field in the second type of RTP header extension based on one or more events associated with the first type of RTP header extension.

Clause 8A. The method of clause 7A, wherein the second field in the second type of RTP header extension is indicative of a time an RTP packet comprising the first type of RTP header extension is received by the first computing device or the second computing device.

Clause 9A. The method of any of clauses 1A-8A, wherein the second type of RTP header extension comprises an indicator, the indicator indicating an association between a first RTP packet comprising a first type of RTP header extension and a second RTP packet comprising the second type of RTP header.

Clause 10A. A method comprising: determining, by a first device, a first time indicator, a second time indicator, and a third time indicator of an RTP packet comprising an RTP header extension; and determining, by the first device, a delay based on at least one of the first time indicator, a second time indicator, and a third time indicator.

Clause 11A. The method of clause 10A, wherein the first time indicator, the second time indicator, and the third time indicator comprise respective timestamps.

Clause 12A. The method of clause 10A, wherein the first time indicator and the second time indicator comprise respective timestamps, and wherein the third time indicator is indicative of a time difference between a time the RTP packet is transmitted and a time indicated by the first time indicator.

Clause 13A. The method of any of clauses 10A-12A, wherein the RTP packet is a first RTP packet, and wherein the first time indicator is indicative of a time when a second device transmits a second RTP packet to the first device.

Clause 14A. The method of any of clauses 10A-13A, wherein the RTP packet is a first RTP packet, and wherein the second time indicator is indicative of a time when the first device receives a second RTP packet from a second device.

Clause 15A. The method of any of clauses 10A-14A, wherein the RTP third time indicator is indicative of a time when the RTP packet is transmitted by the first device to a second device.

Clause 16A. The method of clause 10A, wherein the RTP packet is a first RTP packet, the method further comprising: determining, by the first device, that a second RTP packet has not been received from a second device; and based on the second RTP packet not being received from the second device, determining the first time indicator and the second time indicator to be equal to a predetermined value.

Clause 17A. The method of any of clauses 10A-16A, wherein the RTP packet is a first RTP packet, the method further comprising associating the first RTP packet and a second RTP packet.

Clause 18A. A computing device, comprising: one or more memories configured to store an RTP packet; and one or more processors coupled to the memory, the one or more processors being configured to perform any of the methods of clauses 1A-17A.

Clause 19A. The computing device of clause 18A, wherein the computing device comprises a mobile device or an application server.

Clause 20A. A computing device comprising at least one means for performing any of the methods of clauses 1A-17A.

Clause 21A. Computer-readable storage media storing instructions, which, when executed, cause one or more processors to perform any of the methods of clauses 1A-17A.

Clause 1B. A method of determining a delay, the method comprising: transmitting or receiving, by a first device, a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted; transmitting, by the first device, the first RTP packet; receiving, by the first device, a second RTP packet, the second RTP packet comprising the second RTP header extension, the second RTP header extension comprising the first timestamp, a second timestamp indicative of a time at which a second device received the first RTP packet, and a third timestamp indicative of a time at which the second device transmitted the second RTP packet; and determining, based on at least one of the first timestamp, the second timestamp, or the third timestamp, a delay.

Clause 2B. The method of clause 1B, further comprising negotiating, by the first device with the second device, a binding of the first RTP header extension and the second RTP header extension, wherein negotiating the binding comprises transmitting or receiving the SDP message.

Clause 3B. The method of clause 1B or clause 2B, wherein determining the delay is performed by at least one of the first device or another device.

Clause 4B. The method of any of clauses 1B-3B, wherein determining the delay comprises determining a delay from the first device to the second device by subtracting a value of the first timestamp (T1) from a value of the second timestamp (T2), wherein the delay=T2−T1.

Clause 5B. The method of any of clauses 1B-3B, wherein determining the delay comprises determining a delay from the second device to the first device by subtracting a value of the third timestamp (T3) from a value indicative of a time the second RTP packet is received by the first device (T4), wherein the delay=T4−T3.

Clause 6B. The method of any of clauses 1B-3B, wherein determining the delay comprises determining a round trip time (RTT) by subtracting a difference between a value of the third timestamp (T3) and a value of the second timestamp (T2) from a difference between a value indicative of a time the second RTP packet is received by the first device (T4) and a value of the first timestamp (T1), wherein the RTT=(T4−T1)−(T3−T2).

Clause 7B. The method of any of clauses 1B-3B, wherein determining the delay comprises determining a processing delay by subtracting a value of the second timestamp (T2) from a value of the third timestamp (T3), wherein the processing delay=T3−T2.

Clause 8B. The method of any of clauses 1B-7B, wherein the SDP message further comprises an indication of a format of at least one of the first RTP header extension or the second RTP header extension as short or long.

Clause 9B. A first device for processing media data, the first device comprising: one or more memories for storing the media data; and one or more processors communicatively coupled to the one or more memories, the one or more processors being configured to: transmit or receive a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted; transmit the first RTP packet; receive a second RTP packet, the second RTP packet comprising the second RTP header extension, the second RTP header extension comprising the first timestamp, a second timestamp indicative of a time at which a second device received the first RTP packet, and a third timestamp indicative of a time at which the second device transmitted the second RTP packet; and determine, based on at least one of the first timestamp, the second timestamp, or the third timestamp, a delay.

Clause 10B. The first device of clause 9B, wherein the one or more processors are configured to negotiate, with the second device, a binding of the first RTP header extension and the second RTP header extension, wherein as part of negotiating the binding, the one or more processors are configured to transmit or receive the SDP message.

Clause 11B. The first device of clause 9B or clause 10B, wherein the delay comprises a delay from the first device to a second device, and wherein as part of determining the delay, the one or more processors are configured to subtract a value of the first timestamp (T1) from a value of the second timestamp (T2), wherein the delay=T2−T1.

Clause 12B. The first device of any of clauses 9B-11B, wherein the delay comprises a delay from second device to the first device, and wherein as part of determining the delay, the one or more processors are configured to subtract a value of the third timestamp (T3) from a value indicative of a time the second RTP packet is received by the first device (T4), wherein the delay=T4−T3.

Clause 13B. The first device of any of clauses 9B-11B, wherein the delay comprises a round trip time (RTT), and wherein as part of determining the delay, the one or more processors are configured to subtract a difference between a value of the third timestamp (T3) and a value of the second timestamp (T2) from a difference between a value indicative of a time the second RTP packet is received by the first device (T4) and a value of the first timestamp (T1), wherein the RTT=(T4−T1)−(T3−T2).

Clause 14B. The first device of any of clauses 9B-11B, wherein the delay comprises determining a processing delay, and wherein as part of determining the delay, the one or more processors are configured to subtract a value of the second timestamp (T2) from a value of the third timestamp (T3), wherein the processing delay=T3−T2.

Clause 15B. The first device of any of clauses 9B-14B, wherein the SDP message further comprises an indication of a format of at least one of the first RTP header extension or the second RTP header extension as short or long.

Clause 16B. The first device of any of clauses 9B-15B, wherein the first device comprises a mobile device, an extended reality device, or an application server.

Clause 17B. A method of determining a delay, the method comprising: transmitting or receiving, by a second device, a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted; receiving, by the second device, the first RTP packet; transmitting, by the second device, a second RTP packet, the second RTP packet comprising the second RTP header extension, the second RTP header extension comprising the first timestamp, a second timestamp indicative of a time at which the second device received the first RTP packet, and a third timestamp indicative of a time at which the second device transmitted the second RTP packet; and determining, based on at least one of the first timestamp, the second timestamp, or the third timestamp, a delay.

Clause 18B. The method of clause 17B, further comprising negotiating, by the second device with a first device, a binding of the first RTP header extension and the second RTP header extension, wherein negotiating the binding comprises transmitting or receiving the SDP message.

Clause 19B. The method of clause 17B or clause 18B, wherein determining the delay is performed by at least one of the second device or another device.

Clause 20B. The method of any of clauses 17B-19B, wherein determining the delay comprises determining a delay from a first device to the second device by subtracting a value of the first timestamp (T1) from a value of the second timestamp (T2), wherein the delay=T2−T1.

Clause 21B. The method of any of clauses 17B-19B, wherein determining the delay comprises determining a processing delay by subtracting a value of the second timestamp (T2) from a value of the third timestamp (T3), wherein the processing delay=T3−T2.

Clause 22B. The method of any of clauses 17B-21B, wherein the SDP message further comprises an indication of a format of at least one of the first RTP header extension or the second RTP header extension as short or long.

Clause 23B. A second device for processing media data, the second device comprising: one or more memories for storing the media data; and one or more processors communicatively coupled to the one or more memories, the one or more processors being configured to: transmit or receive a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted; receive the first RTP packet; transmit a second RTP packet, the second RTP packet comprising the second RTP header extension, the second RTP header extension comprising the first timestamp, a second timestamp indicative of a time at which the second device received the first RTP packet, and a third timestamp indicative of a time at which the second device transmitted the second RTP packet; and determine, based on at least one of the first timestamp, the second timestamp, or the third timestamp, a delay.

Clause 24B. The second device of clause 23B, wherein the one or more processors are configured to negotiate, with a first device, a binding of the first RTP header extension and the second RTP header extension, wherein as part of negotiating the binding, the one or more processors are configured to transmit or receive the SDP message.

Clause 25B. The second device of clause 23B or clause 24B, wherein the delay comprises a delay from a first device to the second device, and wherein as part of determining the delay, the one or more processors are configured to subtract a value of the first timestamp (T1) from a value of the second timestamp (T2), wherein the delay=T2−T1.

Clause 26B. The second device of clause 23B or clause 24B, wherein the delay comprises a processing delay, and wherein as part of determining the delay, the one or more processors are configured to subtract a value of the second timestamp (T2) from a value of the third timestamp (T3), wherein the processing delay=T3−T2.

Clause 27B. The second device of any of clauses 23B-26B, wherein the SDP message further comprises an indication of a format of at least one of the first RTP header extension or the second RTP header extension as short or long.

Clause 28B. The second device of any of clause 23B-27B, wherein the second device comprises a mobile device, an extended reality device, or an application server.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of determining a delay, the method comprising:
transmitting or receiving, by a first device, a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted;
transmitting, by the first device, the first RTP packet;
receiving, by the first device, a second RTP packet, the second RTP packet comprising the second RTP header extension, the second RTP header extension comprising the first timestamp, a second timestamp indicative of a time at which a second device received the first RTP packet, and a third timestamp indicative of a time at which the second device transmitted the second RTP packet; and
determining, based on at least one of the first timestamp, the second timestamp, or the third timestamp, a delay.

2. The method of claim 1, further comprising negotiating, by the first device with the second device, a binding of the first RTP header extension and the second RTP header extension, wherein negotiating the binding comprises transmitting or receiving the SDP message.

3. The method of claim 1, wherein determining the delay is performed by at least one of the first device or another device.

4. The method of claim 1, wherein determining the delay comprises determining a delay from the first device to the second device by subtracting a value of the first timestamp (T1) from a value of the second timestamp (T2), wherein the delay=T2−T1.

5. The method of claim 1, wherein determining the delay comprises determining a delay from the second device to the first device by subtracting a value of the third timestamp (T3) from a value indicative of a time the second RTP packet is received by the first device (T4), wherein the delay=T4−T3.

6. The method of claim 1, wherein determining the delay comprises determining a round trip time (RTT) by subtracting a difference between a value of the third timestamp (T3) and a value of the second timestamp (T2) from a difference between a value indicative of a time the second RTP packet is received by the first device (T4) and a value of the first timestamp (T1), wherein the RTT=(T4−T1)−(T3−T2).

7. The method of claim 1, wherein determining the delay comprises determining a processing delay by subtracting a value of the second timestamp (T2) from a value of the third timestamp (T3), wherein the processing delay=T3−T2.

8. The method of claim 1, wherein the SDP message further comprises an indication of a format of at least one of the first RTP header extension or the second RTP header extension as short or long.

9. A first device for processing media data, the first device comprising:
one or more memories for storing the media data; and
one or more processors communicatively coupled to the one or more memories, the one or more processors being configured to:
transmit or receive a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted;
transmit the first RTP packet;
receive a second RTP packet, the second RTP packet comprising the second RTP header extension, the second RTP header extension comprising the first timestamp, a second timestamp indicative of a time at which a second device received the first RTP packet, and a third timestamp indicative of a time at which the second device transmitted the second RTP packet; and
determine, based on at least one of the first timestamp, the second timestamp, or the third timestamp, a delay.

10. The first device of claim 9, wherein the one or more processors are configured to negotiate, with the second device, a binding of the first RTP header extension and the second RTP header extension, wherein as part of negotiating the binding, the one or more processors are configured to transmit or receive the SDP message.

11. The first device of claim 9, wherein the delay comprises a delay from the first device to a second device, and wherein as part of determining the delay, the one or more processors are configured to subtract a value of the first timestamp (T1) from a value of the second timestamp (T2), wherein the delay=T2−T1.

12. The first device of claim 9, wherein the delay comprises a delay from second device to the first device, and wherein as part of determining the delay, the one or more processors are configured to subtract a value of the third timestamp (T3) from a value indicative of a time the second RTP packet is received by the first device (T4), wherein the delay=T4−T3.

13. The first device of claim 9, wherein the delay comprises a round trip time (RTT), and wherein as part of determining the delay, the one or more processors are configured to subtract a difference between a value of the third timestamp (T3) and a value of the second timestamp (T2) from a difference between a value indicative of a time the second RTP packet is received by the first device (T4) and a value of the first timestamp (T1), wherein the RTT=(T4−T1)−(T3−T2).

14. The first device of claim 9, wherein the delay comprises determining a processing delay, and wherein as part of determining the delay, the one or more processors are configured to subtract a value of the second timestamp (T2) from a value of the third timestamp (T3), wherein the processing delay=T3−T2.

15. The first device of claim 9, wherein the SDP message further comprises an indication of a format of at least one of the first RTP header extension or the second RTP header extension as short or long.

16. The first device of claim 9, wherein the first device comprises a mobile device, an extended reality device, or an application server.

17. A method of determining a delay, the method comprising:
transmitting or receiving, by a second device, a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted;
receiving, by the second device, the first RTP packet;
transmitting, by the second device, a second RTP packet, the second RTP packet comprising the second RTP header extension, the second RTP header extension comprising the first timestamp, a second timestamp indicative of a time at which the second device received the first RTP packet, and a third timestamp indicative of a time at which the second device transmitted the second RTP packet; and
determining, based on at least one of the first timestamp, the second timestamp, or the third timestamp, a delay.

18. The method of claim 17, further comprising negotiating, by the second device with a first device, a binding of the first RTP header extension and the second RTP header extension, wherein negotiating the binding comprises transmitting or receiving the SDP message.

19. The method of claim 17, wherein determining the delay is performed by at least one of the second device or another device.

20. The method of claim 17, wherein determining the delay comprises determining a delay from a first device to the second device by subtracting a value of the first timestamp (T1) from a value of the second timestamp (T2), wherein the delay=T2−T1.

21. The method of claim 17, wherein determining the delay comprises determining a processing delay by subtracting a value of the second timestamp (T2) from a value of the third timestamp (T3), wherein the processing delay=T3−T2.

22. The method of claim 17, wherein the SDP message further comprises an indication of a format of at least one of the first RTP header extension or the second RTP header extension as short or long.

23. A second device for processing media data, the second device comprising:
one or more memories for storing the media data; and
one or more processors communicatively coupled to the one or more memories, the one or more processors being configured to:
transmit or receive a session description protocol (SDP) message that includes binding information that associates a first RTP header extension and a second RTP header extension for an RTP session, wherein the binding information is indicative of a first timestamp in the first RTP header extension, and the first timestamp in the second RTP header extension, both being indicative of a time at which a first RTP packet including the first RTP header extension is transmitted;
receive the first RTP packet;
transmit a second RTP packet, the second RTP packet comprising the second RTP header extension, the second RTP header extension comprising the first timestamp, a second timestamp indicative of a time at which the second device received the first RTP packet, and a third timestamp indicative of a time at which the second device transmitted the second RTP packet; and
determine, based on at least one of the first timestamp, the second timestamp, or the third timestamp, a delay.

24. The second device of claim 23, wherein the one or more processors are configured to negotiate, with a first device, a binding of the first RTP header extension and the second RTP header extension, wherein as part of negotiating the binding, the one or more processors are configured to transmit or receive the SDP message.

25. The second device of claim 23, wherein the delay comprises a delay from a first device to the second device, and wherein as part of determining the delay, the one or more processors are configured to subtract a value of the first timestamp (T1) from a value of the second timestamp (T2), wherein the delay=T2−T1.

26. The second device of claim 23, wherein the delay comprises a processing delay, and wherein as part of determining the delay, the one or more processors are configured to subtract a value of the second timestamp (T2) from a value of the third timestamp (T3), wherein the processing delay=T3−T2.

27. The second device of claim 23, wherein the SDP message further comprises an indication of a format of at least one of the first RTP header extension or the second RTP header extension as short or long.

28. The second device of claim 23, wherein the second device comprises a mobile device, an extended reality device, or an application server.
